(19) United States
(12) Patent Application Publication
(10) Pub. No.: US 2019/0027015 A1
(43) Pub. Date: Jan. 24, 2019

(54) CROWDSOURCING AND ACTIVE LEARNING TO SUPPORT EVACUATION OF A BUILDING

(71) Applicant: OTIS ELEVATOR COMPANY, Farmington, CT (US)

(72) Inventors: Arthur Hsu, South Glastonbury, CT (US); Sunil Ahuja, Milpitas, CA (US); Ritesh Khire, South Windsor, CT (US)

(21) Appl. No.: 15/314,583

(22) PCT Filed: May 29, 2015
(86) PCT No.: PCT/US15/33169

§ 371 Date: Nov. 29, 2016

Related U.S. Application Data
(60) Provisional application No. 62/005,451, filed on May 30, 2014.

(51) Int. Cl. G08B 25/01; G08B 7/06; G08B 26/00; G08B 27/00

(52) U.S. Cl. CPC G08B 25/016; G08B 27/006; G08B 26/008; G08B 7/066

(57) ABSTRACT

A building event management system for monitoring a building is provided including a plurality of devices located within the building. The plurality of devices includes at least one occupant interaction device. A controller is configured to communicate with the plurality of devices. The controller is configured to gather critical building information from the at least one occupant interaction device when an emergency event has been identified.

### BACKGROUND

Exemplary embodiments of the present disclosure relate to evacuation of a building and, more particularly, to an interactive system for efficiently evacuating people from a building.

Commonly, persons who live or work in a building during an emergency such as a fire, are merely warned of the presence of an emergency event and predetermined exit routes are illuminated regardless of their proximity to the emergency event. These conventional systems often employ a simple siren or alarm in conjunction with illuminated exit signs. More sophisticated systems may include an automated voice directing people to evacuate the building when the system detects an emergency event and enters an alarm state. However, these systems also fail to inform occupants in the building of the location of the emergency event. Furthermore, evacuees do not have any ready mechanism for providing information that they experience or observe during the evacuation other than pulling alarm boxes or calling an emergency operator.

In addition, conventional plans for evacuating a building during an emergency are typically static in nature. Evacuation drills and safety training are widely used to educate occupants of an evacuation plan, for example which corridors and staircases to use to reach a desired. However, for crowded, tall buildings, a static evacuation plan may be insufficient, as the evacuation time is typically great, and the threat may move or propagate with time.

### SUMMARY

According to an embodiment, a building event management system for monitoring a building is provided including a plurality of devices located within the building. The plurality of devices includes at least one occupant interaction device. A controller is configured to communicate with the plurality of devices. The controller is configured to gather critical building information from the at least one occupant interaction device when an emergency event has been identified.

In addition to one or more of the features described above, or as an alternative, in further embodiments the at least one occupant interaction device includes an application configured to communicate with the building event management system.

In addition to one or more of the features described above, or as an alternative, in further embodiments the controller is configured to communicate with the at least one occupant interaction device even when an emergency event has not been identified.

In addition to one or more of the features described above, or as an alternative, in further embodiments the controller is configured to broadcast an alert to the at least one occupant interaction device.

In addition to one or more of the features described above, or as an alternative, in further embodiments the controller is configured to actively gather information from the at least one occupant interaction device.

In addition to one or more of the features described above, or as an alternative, in further embodiments the controller is configured to passively gather information from the at least one occupant interaction device.

In addition to one or more of the features described above, or as an alternative, in further embodiments the at least one occupant interaction device includes a mobile device carried by an occupant of the building.

In addition to one or more of the features described above, or as an alternative, in further embodiments the controller is configured to track a position of the mobile device.

In addition to one or more of the features described above, or as an alternative, in further embodiments the controller is configured to trigger a certain action when the mobile device has reached a predetermined location.

In addition to one or more of the features described above, or as an alternative, in further embodiments the controller is configured to prompt the occupant carrying the mobile device for information.

In addition to one or more of the features described above, or as an alternative, in further embodiments the plurality of devices includes one or more sensors mounted within the building.

In addition to one or more of the features described above, or as an alternative, in further embodiments the plurality of devices includes at least one movable device configured to move within the building.

According to yet another embodiment, a method of operating a building event management system is provided including learning normal behavior of building occupants. The behavior of the building occupants is monitored to identify abnormal behavior to improve building operation.

In addition to one or more of the features described above, or as an alternative, in further embodiments the abnormal behavior indicates the presence of an emergency event.

According to yet another embodiment, a method of evacuating a building is provided including learning normal behavior of building occupants during an emergency event. The building occupants are directed to an alternate evacuation path based on the learned normal behavior, a location of the building occupants, and a location of the emergency event.

### BRIEF DESCRIPTION OF THE DRAWINGS

The subject matter, which is regarded as the present disclosure, is particularly pointed out and distinctly claimed at the conclusion of the specification. The foregoing and other features and advantages of the present disclosure are apparent from the following detailed description, taken in conjunction with the accompanying drawings, in which:

FIG. 1 is a perspective view of an example of an elevator system; and

FIG. 2 depicts a portion of an elevator system according to an embodiment of the present disclosure.

The detailed description of the present disclosure describes exemplary embodiments of the present disclosure, together with some of the advantages and features thereof, by way of example with reference to the drawings.

### DETAILED DESCRIPTION

Referring now to the FIGS., an example of a building 20 including a building event management system 30 is illustrated in more detail Although the building 20 as illustrated and described herein is a single structure, embodiments where the building 20 includes a plurality of interconnected or separate structures are also within the scope of the present disclosure. The building event management system 30 includes a controller 32 configured to receive data from one or more devices within the building. In addition, it should be understood to a person having ordinary skill in the art that in one embodiment, the building event management system 30 may be a single centralized system configured to monitor everything within a building 20. However, in other embodiments, the building monitoring system 30 may be decentralized and include several different portions, each of which may be configured to monitor a designate part or system of the building 20.

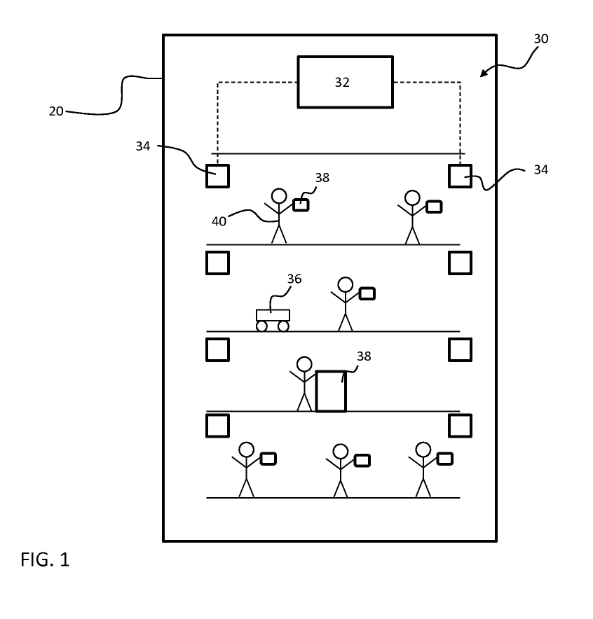

In one embodiment, as illustrated in FIG. 1, at least a portion of the devices configured to communicate with the building event management system 30 include a plurality of static sensors 34 positioned at various locations throughout the building 20. Examples of static sensors 34 include, but are not limited to motion sensors, temperature sensors, smoke detectors, people counters, video and photographic sensors for example.

The building event management system 30 may additionally be configured to track or collect information from one or more movable devices 36. In one embodiment, the movable devices 36 include robots, such as manually controlled, semi-autonomous, or fully autonomous robots for example, that can travel to portions or areas of the building 20 that are not monitored by or are hidden from sensors. The movable devices 36 are configured to collect and communicate relevant information, such as threat status, and evacuation flow for example, to the controller 32.

The building event management system 30 may also be configured to communicate with one or more occupant interaction devices 38. The occupant interaction devices 38 include display devices generally fixed within an area of a building, such as a touchscreen location within a hallway for example. During normal operation, the touchscreen may be configured to display information, such as the weather or a location of tenants within the building for example. However, during an emergency event, the occupant interaction devices 38 may be used to gather information from one or more building occupants 40 during egress. For example, the controller 24 may collect environmental data, such as whether the hallway is filled with smoke, or whether a large quantity of people have gather at a nearby exit creating a choke point. In addition, a lack of input provided to an occupant interaction device 38 may be used, at least in part, to infer that an emergency event may be in proximity to a given occupant interaction device 38,

Alternatively or in addition, the occupant interaction devices 38 may include one or more mobile devices that are generally transported by an occupant 40 of the building 20, such as a smartphone, tablet, computer, personal digital assistant, cellular devices, identification badges, and other personal mobile accessories for example. The mobile devices may be configured to communicate with the controller 32 of the building event management system 30 through one or more communication methods, including, but not limited to Bluetooth, radio frequency, near field communication, wireless local area network, global system for mobile communication, or a cellular network for example. In one embodiment, the building event management system 30 is configured to communicate with the mobile devices 38 only during a defined emergency event, such as a fire for example. However, embodiments where the building event management system 30 is configured to communicate with the mobile devices 36 at any time are also within the scope of the present disclosure.

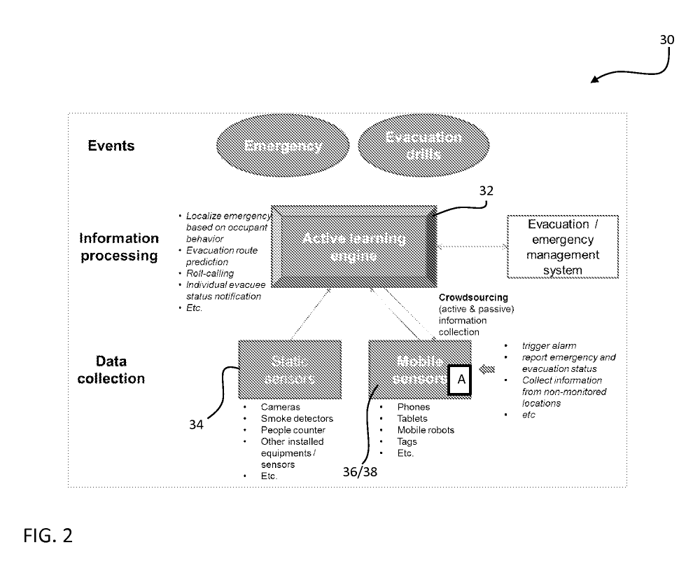

In one embodiment, an application, also commonly referred to an as “app” may be downloaded or run on a mobile device 38 and used as the interface for communication between the building event management system 30 and the mobile device 38. Operation of the app, illustrated schematically at A in FIG. 2, may be initiated by a building occupant 40 upon detection of an emergency event. Alternatively, the building event management system 30 may be configured to automatically open the app on any mobile device 38 upon detection of an emergency event.

During an emergency event, communication between the building event management system 30 and one or more of the devices, such as the static sensors 34 or mobile devices 38, is used to gather critical building information. With respect to the mobile devices 38, the building event management system 30 may be configured to activate the subscribed mobile devices 38 to passively gather information therefrom. For example, the building event management system 30 may track the position of an occupant 40 carrying a mobile device 38 within the building 20 or monitor whether an occupant 40 exits the building 20 or reaches a designated safe location. In addition, the building event management system 30 may broadcast alerts or other information such as a location of a threat or event or a recommended egress path based on the location of the event. In one embodiment, the building event management system 30 is configured to communicate with a device (not shown) configured to monitor the vital statistics of an occupant 40. Upon detection that the monitored vitals of an occupant 40 are at an unsafe level, the building event management system 30 may issue a warning to the occupant 40 and/or contact appropriate personnel for the requisite medical attention.

Alternatively, or in addition, the building event management system 30 may be configured to actively collect information from occupants 40 carrying the mobile devices 36. For example, a building occupant 40 may be able to indicate the occurrence of an emergency event, or provide a status update such as a blocked passage or a stairwell filled with smoke. In one embodiment, the building event management system 30, through the app, may be able to prompt an occupant 40 for specific information, such as whether a corridor is blocked, or for a live video stream for example. The information provided by occupants 40 via the mobile devices 36 will be used to actively update the position of the threat or event, provide feedback to the occupants 40, and possibly recommend an egress route depending on an occupant's position. The app may also be configured to automatically, or alternatively, prompt an occupant 40 to provide an updated status on one or more social media platforms or send a message indicating that the occupant 40 has successfully exited the building 20 or reached a safe location.

As the controller 32 gathers information in real-time from the occupant interaction devices 38, movable devices 36, and static sensors 34 positioned within the building 20, the controller 32 is configured to actively learn general occupant behavior. By monitoring a general occupant behavior during an emergency event, the learned behavior may be used for more efficient evacuation planning for future emergencies. For example, general occupant behavior during an emergency event may be collected by performing one or more evacuation drills. From this the controller 32 may learn the movement of the people 40 within the building 20 to estimate a number of people 40 in different parts of the building 20 and use that information to predict potential choke points that will slow egress therefrom. In such instances, the building event management system 32 may be configured to direct occupants 40 in certain areas of the building 20 to different exits to optimize the time required to evacuate the building 20.

In another embodiment, learning general occupant behavior during normal, non-emergent conditions may be used to detect abnormal conditions. Abnormal conditions may be used diagnostically to indicate a malfunction or certain building equipment. Alternatively, abnormal conditions may indicate the presences of a threat or emergency condition within the building. For instance, the controller 32 of the building event management system 30 may monitor a pattern of movement of the occupants 40, to suggest that a threat may exist in a common traffic area that occupants 40 are avoiding. In addition, the building event management system 30 may also be able to access scheduling information of the occupants 40, such as via a computerized calendar for example, to estimate normal behavior.

A building event management system 30 configured to crowdsource and actively learn based on the data collected from said crowdsourcing will provide more efficient evacuation planning. The ability for allowing users 38 to initiate an alarm and provide status updates during an emergency event, generates more accurate information regarding the threat and egress paths. By tracking the location of each occupant 40 within the building 20, the system 30 will be able to accurately monitor which occupants 40 have safely exited, thereby limiting the time necessary to identify and locate missing persons. In addition, the active learning ability of the building event management system 30 may allow for detection of threats for which special sensors are not available, such as an active shooter for example.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, or equivalent arrangements not heretofore described but which are commensurate with the spirit and scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A building event management system for monitoring a building, comprising:
a plurality of devices location within the building, the plurality of devices including at least one occupant interaction device; and
a controller configured to communicate with the plurality of devices, wherein the controller is configured to gather critical building information from the at least one occupant interaction device when an emergency event has been identified.

2. The building event management system according to claim 1, wherein the at least one occupant interaction device includes an application configured to communicate with the building event management system.

3. The building event management system according to claim 1, wherein the controller is configured to communicate with the at least one occupant interaction device even when an emergency event has not been identified.

4. The building event management system according to claim 1, wherein the controller is configured to broadcast an alert to the at least one occupant interaction device.

5. The building event management system according to claim 1, wherein the controller is configured to actively or passively gather information from the at least one occupant interaction device.

6. (canceled)

7. The building event management system according to claim 1, wherein the at least one occupant interaction device includes a mobile device carried by an occupant of the building.)

8. The building event management system according to claim 7, wherein the controller is configured to track a position of the mobile device.)

9. The building event management system according to claim 8, wherein the controller is configured to trigger a certain action when the mobile device has reached a predetermined location.)

10. The building event management system according to claim 7, wherein the controller is configured to prompt the occupant carrying the mobile device for information.

11. The building event management system according to claim 1, wherein the plurality of devices includes one or more sensors mounted within the building.

12. The building event management system according to claim 1, wherein the plurality of devices includes at least one movable device configured to move within the building.

13. A method of operating a building event management system, comprising:
learning normal behavior of building occupants; and
monitoring behavior of the building occupants to identify abnormal behavior to improved building operation.

14. The method of operating a building event management system according to claim 13, wherein the abnormal behavior indicates the presence of an emergency event.

15. A method of evacuating a building, comprising:
learning normal behavior of building occupants during an emergency event; and
directing building occupants to an alternate evacuation path based on said learned normal behavior, a location of the building occupants, and a location of the emergency event.
